(19) United States
(12) Patent Application Publication
(10) Pub. No.: US 2024/0082698 A1
(43) Pub. Date: Mar. 14, 2024

(54) COMPUTER GAMING DEVICE WITH DOCKING FEATURES

(71) Applicant: Branden Duncan, Eden Prairie, MN (US)

(72) Inventor: Branden Duncan, Eden Prairie, MN (US)

(21) Appl. No.: 17/941,772

(22) Filed: Sep. 9, 2022

(51) Int. Cl. A63F 13/24

(52) U.S. Cl. CPC A63F 13/24

(57) ABSTRACT

A system including one or more processors; computer memory storing instructions, that when executed by the one or more processors, cause the one or more processors to perform operations including operate in a mouse-mode, including receiving mouse inputs from a connected device, performing functions based upon the mouse inputs; transition from the mouse-mode to operating in a joystick-mode based upon receiving a docking event notification from the connected device; operate in a joystick-mode, including receiving joystick inputs from the connected device, performing functions based upon the joystick inputs; and transition from the joystick-mode to operating in the mouse-mode based upon receiving an undocking event notification from the connected device.

### FIELD OF THE DISCLOSURE

The disclosure relates to a computer gaming device.

### BACKGROUND

Computers receive input from connected input devices to facilitate user interaction and control of programs executed by the computer. Examples of input devices can include a keyboard, a touch pad, a mouse, a trackball, a joystick, or a game pad. These input devices communicate with the computer through a communication interface which can be wired (e.g., USB), or wireless (e.g., Bluetooth™). The user interacts with the input device to provide commands to the computer and control the position of a command marker displayed by the computer. In some examples, the commands and positions are received by the computer and mapped to commands of programs currently being executed by the computer.

### SUMMARY

This document describes a computer gaming device which is dockable with a base to operate as either a computer mouse or a joystick. The computer gaming device operates as a computer mouse when undocked from the base, and as a joystick when docked. The computer gaming device changes from mouse-mode to joystick-mode when a user docks the computer gaming device to the base, and vice-versa when the user undocks the computer gaming device from the base.

When in mouse-mode, the computer gaming device operates like a computer mouse, generating position information based on relative motion between the device and a surface. When in joystick-mode, the computer gaming device operates like a joystick, generating position information based on relative motion from a home position. The user moves the device away from the home position to generate position information, and the base returns the computer gaming device to the home position. The user interacts with one or more buttons, switches, or wheels of the computer gaming device which generates input commands to be received by a connected computing device 140.

In one example, disclosed herein is a system, the system including one or more processors; computer memory storing instructions, that when executed by the one or more processors, cause the one or more processors to perform operations including operate in a mouse-mode, including receiving mouse inputs from a connected device, performing functions based upon the mouse inputs; transition from the mouse-mode to operating in a joystick-mode based upon receiving a docking event notification from the connected device; operate in a joystick-mode, including receiving joystick inputs from the connected device, performing functions based upon the joystick inputs; and transition from the joystick-mode to operating in the mouse-mode based upon receiving an undocking event notification from the connected device.

In one example, disclosed herein is a computer-readable medium tangibly storing instructions that, when executed by one or more processors of a computing device, cause the one or more processors to perform operations including operate in a mouse-mode, including receiving mouse inputs from a connected device, performing functions based upon the mouse inputs; transition from the mouse-mode to operating in a joystick-mode based upon receiving a docking event notification from the connected device; operate in a joystick-mode, including receiving joystick inputs from the connected device, performing functions based upon the joystick inputs; and transition from the joystick-mode to operating in the mouse-mode based upon receiving an undocking event notification from the connected device.

In one example, disclosed herein is a computer gaming device, including a receptacle with a docking sensor; a position sensor; one or more control mechanisms; a connector; one or more processors; the computer gaming device configured to, using the one or more processors generate a docking event notification in response to a first change in phenomena sensed by the docking sensor; generate an undocking event notification in response to a second change in phenomena sensed by the docking sensor; generate user input commands based upon activation of one or more control mechanisms; generate position information based upon motion of the device; and transmit the docking event notification, undocking event notification, user input commands, and position information to a computing device connected via the connector.

In some examples, the computer gaming device can include a housing having an upper surface having a dome shape conforming to a palm, the one or more control mechanisms are arranged on the upper surface, and a planar bottom surface the position sensor and receptacle are arranged on the bottom surface. The housing can be composed of a polymer material. The docking sensor can be a Hall Effect sensor, optical sensor, or bump sensor. The docking sensor can be arranged within the receptacle to sense a phenomena from a phenomena element arranged within the receptacle. The position sensor can be an optical sensor. The connector can be a wired connector. The connector can be a wireless connector, and further comprises a power source. The computer gaming device can further include a power connector configured to receive power from an external power source.

In one example, disclosed herein is a system, the system including a computer device, including one or more processors; computer memory storing instructions, that when executed by the one or more processors, cause the one or more processors to perform operations including operate in a mouse-mode and in a joystick-mode, wherein while operating in the mouse-mode, receiving position information from a connected device and interpreting the position information as mouse position; while operating in the joystick-mode, receiving the position information from the connected device and interpreting the position information as joystick position.

In some examples, the system further can include a computer gaming device, including a receptacle with a docking sensor; a position sensor; one or more control mechanisms; a connector; one or more processors; the computer gaming device configured to, using the one or more processors generate a docking event notification in response to a first change in phenomena sensed by the docking sensor; generate an undocking event notification in response to a second change in phenomena sensed by the docking sensor; generate user input commands based upon activation of one or more control mechanisms; generate position information based upon movement of the device; and transmit the docking event notification, undocking event notification, user input commands, and position information to a computing device connected via the connector. The system can include a second computer gaming device connected to the computer device. The system can include a second base corresponding to the second computer gaming device. The system can include a base, including a dish, configured to return to a home position; and a post connected to the dish, including a phenomena element arranged at a position detectable by the docking sensor of the computer gaming device. The post comprises a locking element which reversibly couples to the receptacle. The joystick information can include a rotation, a tilt, or a translation.

Particular examples of the subject matter described in this specification can be implemented so as to realize one or more of the following technical advantages. First, a computer gaming device that is interoperable between two input modes increases the utility of the device to the end user. The user can minimize expenses related to single-use input devices and by purchasing one device for controlling the computer in two interchangeable modes, alternative to two devices operating in a single input mode each.

Second, use of a Hall Effect sensor can be configured to be more accurate than other types of sensors, allowing for accurate docking detection with the base. An accurate docking sensor increases true positive docking signals received by the computer gaming device.

Third, the docking sensor being arranged within a receptacle in the base of the device reduces false positive docking signals. The docking sensor can have a sensing distance below the receptacle height such that objects that generate magnetic fields but are not within the receptacle do not trigger a docking event notification from the computer gaming device.

The details of one or more embodiments are set forth in the accompanying drawings and the description below. Other features and advantages will be apparent from the description and drawings, and from the claims.

### DESCRIPTION OF DRAWINGS

FIG. 1 is a schematic diagram of a user docking the computer gaming device with the base while operating a computing device.

FIG. 2A is a perspective schematic diagram of the computer gaming device docked with the base.

FIG. 2B is a perspective schematic diagram of the base showing the post and dish.

FIG. 3A is a perspective schematic diagram of the base.

FIG. 3B is a schematic diagram of a dish within the base being in a home position.

FIG. 3C is a schematic diagram of the dish being returned to the home position.

FIG. 4A is a top-view schematic diagram of the relative motions of the computer gaming device docked to the base.

FIG. 4B is a top-view schematic diagram of optional combinations of computer gaming devices for input to a computing device.

FIG. 5 is a schematic diagram of two computer gaming devices operating with a computing device.

FIG. 6 is a swim-lane diagram showing the flow of information when the computer gaming device is connected to a computing device.

FIG. 7 is a schematic diagram that shows an example of a computing device.

FIGS. 8A and 8B are photographic depictions of a spring encircling a post of a dish, and the spring removed from the post, respectively.

In the figures, like references indicate like elements.

### DETAILED DESCRIPTION

Examples of computer input devices include a joystick and a mouse. A joystick is an input device including a hand-operated member that pivots on a base and returns to a home position. The joystick transmits information to the computer including the angle, direction, or magnitude of displacement the member makes relative to the home position. Joysticks often have supplementary control surfaces to control various aspects of the computer.

A mouse is a hand-operated input device that detects two-dimensional motion relative to a surface. This detected motion is typically translated into the motion of a control icon, e.g., a pointer, on a display. The control icon allows the user to control a graphical user interface of the computer based on the displayed position of the control icon. In some examples, the mouse or joystick controls the image displayed providing the user with changing perspectives of a virtual environment.

In addition to moving the control icon or image perspective, mice and joysticks have one or more control mechanisms, such as buttons and scroll wheels. The computer gaming device transmits control input to the connected computing device when the control mechanisms are operated by the user. The received control input allow operation of the computer gaming device, such as selection of a menu item on a display or a command interpreted by the program being executed. This document describes a computing gaming device which can operate as a mouse or a joystick based on whether the computer gaming device is undocked or docked, respectively, from a base.

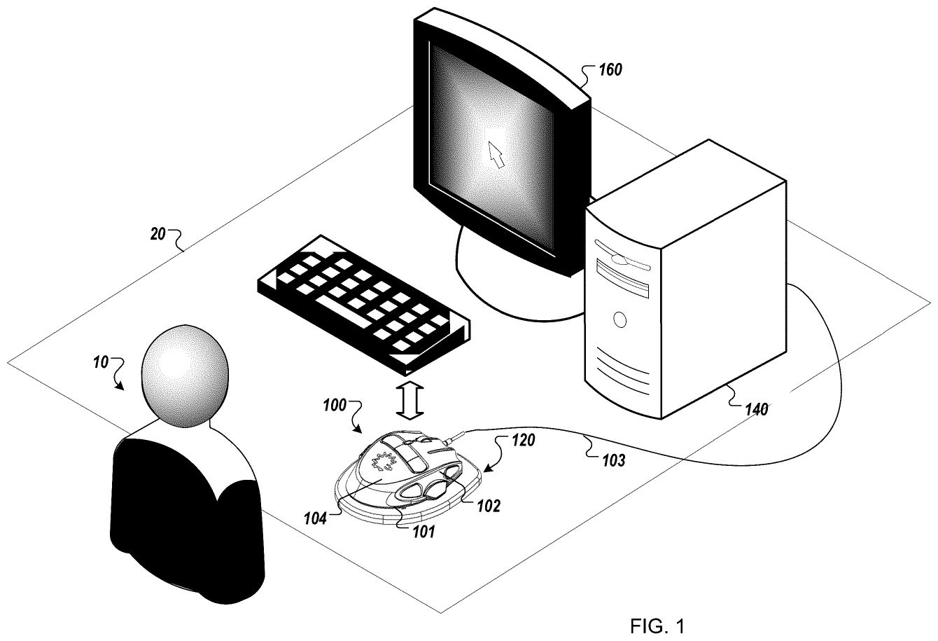

A user operates the computer gaming device when connected to a computing device to control the operation of displayed programs. Referring to FIG. 1, a perspective view of a user 10 interacting with a computer gaming device 100 to control a computing device 140 is shown. In an example, the user 10 places the palm of a hand on the upper surface 104 of the computer gaming device 100 and uses one or more digits, e.g., fingers, to operate one or more control mechanisms 102. The user 10 moves the hand which induces motion in the computer gaming device 100 while the hand is in contact with the computer gaming device 100. The computer gaming device 100 detects the motion of the computer gaming device 100 and the operation of one or more control mechanisms 102 and interprets the motion and control operations as motion-input and command-input, respectively.

The user 10 operates the computer gaming device 100 as a computer joystick, e.g., in joystick-mode, when docked to a base 120 shown in FIG. 1. The user 10 causes movement, e.g., tilt, rotation, or translation, in the computer gaming device 100 which is received as joystick-input by the computing device 140. When docked, the user 10 conveys the computer gaming device 100 in a direction along the plane of the base 120. The base 120 produces a restoring force which urges the computer gaming device 100 to return to a home position. The restoring force returns the computer gaming device 100 to the home position when the user 10 ceases conveying the computer gaming device 100 in the direction along the plane. The computer gaming device 100 detects the motion base 120 beneath the computer gaming device 100 and interprets the motion-input as joystick-input.

Alternatively, the user 10 operates the computer gaming device 100 as a mouse, e.g., in mouse-mode, by conveying the computer gaming device 100 across a surface 20, e.g., a flat, planar surface, supporting the device 100. The computer gaming device 100 detects the motion of the surface 20 beneath the computer gaming device 100 and interprets the detected motion as mouse-input.

An example of the computer gaming device 100 includes a power source, e.g., a battery, for providing power to the components of the computer gaming device 100. In some examples, the computer gaming device 100 receives power through the connector 103, which can include power from the computing device 140. In additional examples, the computer gaming device 100 includes a power inlet, e.g., a plug-in, for receiving power from an external power source which is different than the computing device 140.

The computer gaming device 100 is connected to, e.g., in electronic communication with, a computing device 140. The computer gaming device 100 includes a connector 103 to connect to the computing device 140. The connector 103 can be wired (e.g., USB) or wireless (e.g., Bluetooth™). The computer gaming device 100 transmits input generated through user interaction to the computing device 140 through the connector 103.

The computing device 140 is connected to a computer screen 160 displaying images. The computing device 140 receives input from the connector 103 and maps the received input to various operations in a program being executed by the computing device 140. An example includes the computing device 140 receiving motion-input and/or command-input and causing a program to change the image displayed on the computer screen 160.

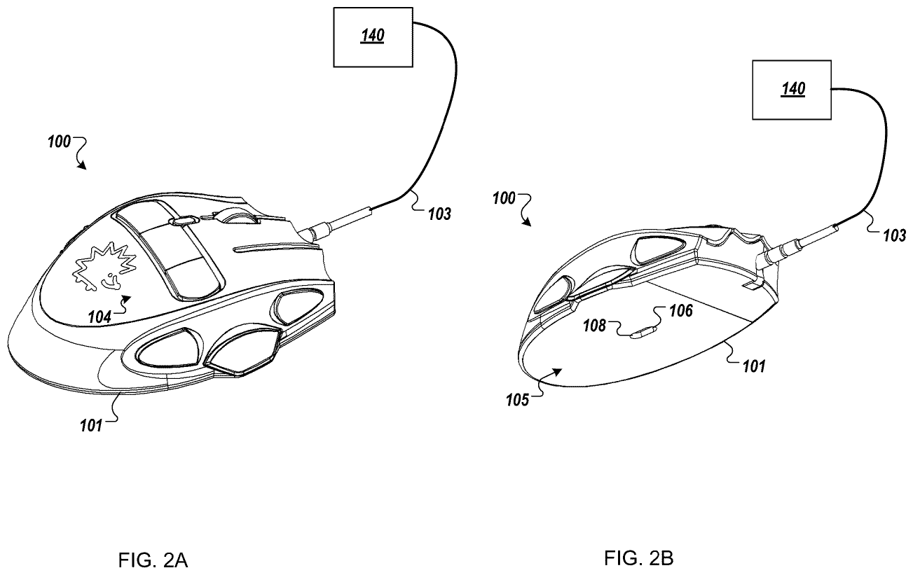

Details of components of the computer gaming device 100 are shown in FIGS. 2A and 2B. FIG. 2A shows a top-perspective view of the computer gaming device 100 and FIG. 2B shows a bottom-view the computer gaming device 100. The computer gaming device 100 includes a housing 101 having an upper surface 104 and a bottom surface 105. The upper surface 104 is curved and the bottom surface 105 is substantially flat, e.g., planar.

The upper surface 104 has a dome-shape, e.g., a shape which conforms to the palm of the user 10 and facilitates comfortable and ergonomic one-handed operation. In operation, the user 10 places a palm into contact with the upper surface 104 such that motions of the palm correspond to motions of the computer gaming device 100.

The planar bottom surface 105 facilitates operation of the computer gaming device 100 on surfaces. A recess in the bottom surface 105 forms a receptacle 108 which is configured to receive a portion of the base 120 during docking. A position sensor 106 is arranged within receptacle 108 to detect relative motion between the bottom surface 105 and the surface beneath, such as surface 20, or the base 120 of FIG. 1.

In some examples, the position sensor 106 is a light-based sensor, e.g., a laser-based sensor, or an LED-based sensor, which emits a light signal. The position sensor 106 detects light reflected from the surface beyond the receptacle 108 and determines a relative motion of the optical position sensor 106 to the planar surface based on the reflected light. The computer gaming device 100 produces position information indicative of the relative motion.

In an alternative example, the position sensor 106 includes a track ball such that motion of the computer gaming device 100 across the planar surface induces rotational motion in the track ball. The rotational motion is detected by the position sensor 106 and the computer gaming device 100 translates the rotational motion into relative motion across the planar surface.

The receptacle 108 recedes into the bottom surface 105 by a distance and is shaped to receive the post. The computer gaming device 100 includes at least one docking sensor 110 arranged within the receptacle 108 and configured to detect a phenomena. In some examples, the docking sensor 110 is arranged at an apex, e.g., along a centerline, of the receptacle 108. In some examples, the receptacle 108 includes two or more docking sensors 210 to detect the phenomena within the receptacle 108.

In some examples, the phenomena is a magnetic field and the docking sensor 110 is a magnetic sensor, such as a Hall Effect sensor. A Hall Effect sensor is a magnetic sensor which detects the presence and magnitude of a magnetic field. In alternative examples, the docking sensor 110 is an optical sensor, switches (e.g., mechanical or electromagnetic switches), a magnetic sensor, or a bump sensor (e.g., snap-action switches or limit switches).

The computer gaming device 100 is reversibly dockable with the base 120. The user 10 orients the computer gaming device 100 above the base 120 and conveys the computer gaming device 100 downward to dock the computer gaming device 100 to the base 120. The downward motion of the computer gaming device 100 causes the computer gaming device 100 to dock with the base 120.

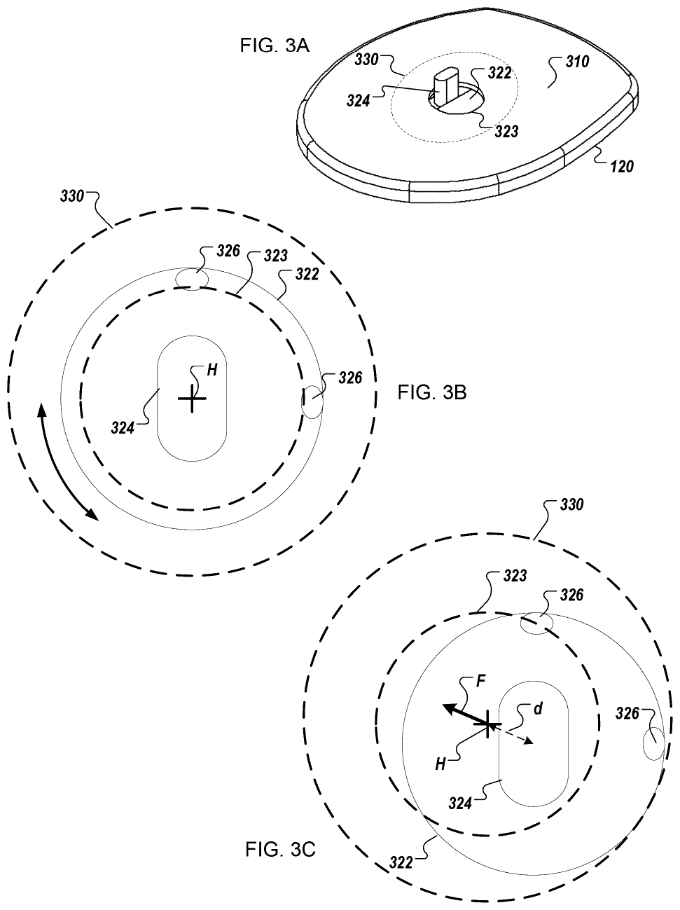

FIG. 3A shows a perspective top-view of the base 120. The base 120 provides a stable, planar platform for user operation of the computer gaming device 100 when docked. The base 120 is composed of a rigid, durable material that provides a stationary planar surface when the computer gaming device 100 is operated. In some examples, the base 120 is composed of a polymer material, such as a plastic material; or a metallic material; or metallic components. Example polymer material can include thermoplastics, injection-molded plastics, etc.

In some examples, the bottom surface of the base 120 in contact with the supporting surface, e.g., surface 20, can include a pad having a coefficient of friction greater than the base 120 material for increased stability during operation of the computer gaming device 100. For example, the base 120 can include a pad having high surface roughness, such as a rubber, micro-fiber, or polymer foam.

A constraining cavity 330 is arranged in a central region within the volume of the base 120 and an aperture 323 connects the constraining cavity 330 to the upper surface 310. The constraining cavity 330 is shown in FIGS. 3A-3C as a dashed outline representing the positioning within the volume of the base 120. Arranged within the constraining cavity 330 is a dish 322. The dish 322 is configured to move along the plane of the base 120 within the constraining cavity 330. A post 324 extends perpendicularly from the dish 322, e.g., perpendicular to the plane of the upper surface 310.

A phenomena element is arranged at the distal end of the post 324, e.g., at the end of the post 324 furthest from the dish 322. The phenomena element provides a phenomena, e.g., a detectable effect, which corresponds with the docking sensor 110 mode of detection. When the computer gaming device 100 docks with the base 120, the post 324 extends into the receptacle 108 and the phenomena element is brought into proximity, e.g., detection distance, of the docking sensor 110. When the docking sensor 110 detects the phenomena element, the docking sensor 110 sends a docking signal to the computer gaming device 100 indicative of the presence of the phenomena element. The computer gaming device 100 generates a docking event notification responsive to the docking signal.

When the docking sensor 110 ceases to detect the phenomena element, the docking sensor 110 sends an undocking signal to the computer gaming device 100 indicative of the absence of the phenomena element. The computer gaming device 100 generates an undocking event notification responsive to the undocking signal.

For example, in examples in which the docking sensor 110 is a magnetic sensor, the phenomena element is a magnet producing a magnetic phenomenon, e.g., a static magnetic field. In examples in which the docking sensor 110 is an optical sensor, the phenomena element is a reflective shape or surface. In an example in which the docking sensor 110 is a bump sensor, the phenomena element is a rigid surface arranged to interact with the docking sensor 110 when the computer gaming device 100 is docked.

When the computer gaming device 100 is docked with the base 120, the bottom surface 105 is parallel with the upper surface 310 of the base 120 and the position sensor 106 is oriented to detect motion of the computer gaming device 100 relative to the base 120. While docked, movement of the computer gaming device 100 causes movement of the dish 320 within the constraining cavity 330. The dish 322 includes resistance elements 326 which induce a restoring force on the dish 322 when the dish 322 is displaced from a home position. Referring to FIGS. 3A and 3B, the motion of the dish 322 within the constraining cavity 330 is described. The FIGS. 3A and 3B depict a top-view of the dish 322, including the post 324, and resistance elements 326, within the constraining cavity 330.

The dish 322 is configured to return to a home position (e.g., represented by a cross shape, labeled H in FIGS. 3B and 3C) within the constraining cavity 330. The resistance elements 326 are arranged on the dish 322, within the constraining cavity 330, or both, to restore the dish 322 to the home position, H, when the dish 322 is displaced. In some examples, the resistance elements 326 are magnets arranged around the dish 322 and/or in one or more surfaces of the constraining cavity 330. In some examples, the resistance elements 326 are springs connecting the dish 322 to the one or more surfaces of the constraining cavity 330.

In one example, the dish 322 is configured to rotate within the plane of the cavity 330 (e.g., rotation about the longitudinal axis of the post 324, e.g., clockwise or counter-clockwise, shown by the curved arrow in FIG. 3B) and return to a default orientation. Rotation within the plane of the cavity 330 can provide yaw input when the computer gaming device 100 is docked to the base 120. In a further example, the dish 322 is configured to tilt within the cavity 330 to provide pitch or roll input (e.g., angular deflection of the longitudinal axis of the post 324 with respect to the plane of the base 120) and return to a default orientation.

For example, FIG. 3B shows the arrangement of the dish 322 within the constraining cavity 330 when no force is applied to the post 324, e.g., when the user 10 is not in contact with the computer gaming device 100 when docked on the base 120. The dish 322 is centered on the home position, H, within the constraining cavity 330 such that the post 324 extends upwardly through the aperture 323.

FIG. 3C shows the arrangement of the dish 322 within the constraining cavity 330 when the dish 322 is displaced from the home position by a distance, d. The interaction of the resistance elements 326 induces a restoring force, F, on the dish 322 which is in a parallel and opposite direction from the displacement, d. The restoring force, F, causes motion of the dish 322 according to the magnitude and direction of the restoring force.

The restoring force urges the dish 322 toward the home position. When the dish 322 is restored to the home position, the restoring force is zero. In this manner, the resistance elements 326 restore the dish 322 position to the home position subsequent to the initial displacement.

In some examples, the post 324 includes a locking element which is received by a mating element in the receptacle 108 when the computer gaming device 100 is docked with the base 120. The locking element is reversibly coupled with the mating element and constrains motion of the computer gaming device 100 to motion of the dish 322 when docked. In an example, a coupling motion, e.g., a twist in a first rotational direction, couples the locking element to the mating element. In such an example, a decoupling motion, e.g., a twist in the reverse direction, of the computer gaming device 100 with respect to the post 324 decouples the locking element from the mating element and allows undocking of the computer gaming device 100 from the post 324.

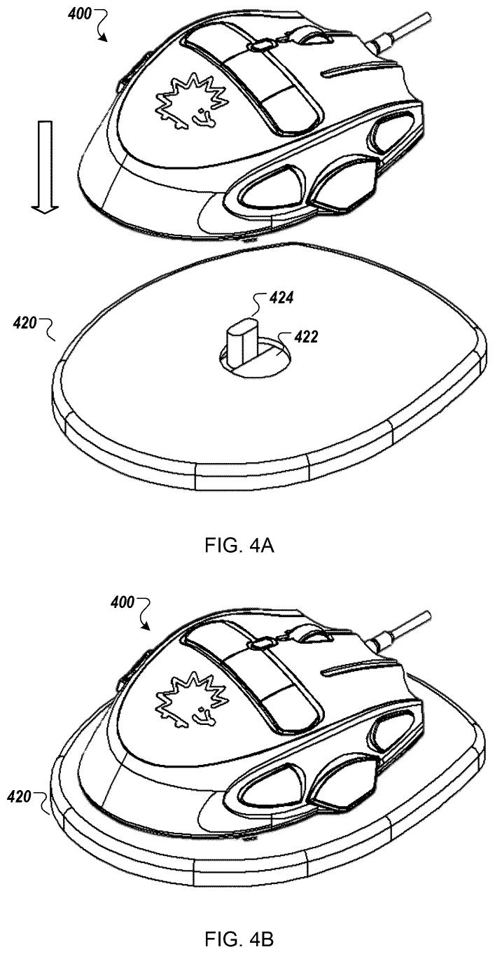

FIGS. 4A and 4B show an arrangement of an example of a computer gaming device 400 and base 420 during a docking event. In general, the components of computer gaming device 100 in FIG. 1 can provide the components of the computer gaming device 400. FIG. 4A shows the computer gaming device 400 arranged above a base 420 and oriented such that the receptacle is aligned with the post 424 extending from the dish 422. The computer gaming device 400 is conveyed toward the base 420 such that the post 424 inserts into the receptacle, as shown in FIG. 4B.

The post 424 being arranged within the receptacle brings the phenomena element into proximity with the docking sensor. The docking sensor detects the phenomena element based on the proximity and generates a docking signal. The computer gaming device 400 receives the docking signal and produces a docking event notification based on the docking signal.

The computer gaming device 400 is considered docked with the base 420 while the post 424 is arranged within the receptacle, e.g., while the phenomena element is in proximity with the docking sensor. While docked, motion of the computer gaming device 400 is coupled to motion of the post 424 and thereby motion of the dish 422. The dish 422 being arranged within the base 420 constrains computer gaming device 400 motion to the plane of the base 420. The position sensor detects the motion relative to the base 420 and transmits a motion signal to the computer gaming device 400. The computer gaming device 400 receives the motion signal and transmits the motion information to a connected computing device.

Conveying the computer gaming device 400 away from the base 420 removes the post 424 from the receptacle thereby reverting the arrangement of the computer gaming device 400 and base 420 to that of FIG. 4A. When the docking sensor is removed from proximity with the phenomena element, the docking sensor ceases producing the docking signal and the computer gaming device 400 transmits an undocking event notification to the computing device 440.

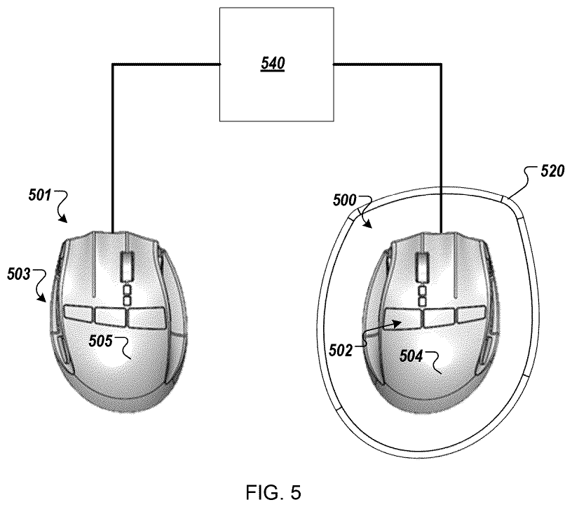

The computer gaming device 100, such as described in any implementation herein, can be connected to a computing device 140 either singly or in combination with additional computer gaming devices 100. FIG. 5 shows an exemplary implementation in which a first computer gaming device 500 and a second computer gaming device 501, collectively devices 500 and 501, are connected to a computing device 540. The right computer gaming device 500 in FIG. 5 is docked with a base 520 and operable in joystick-mode provides joystick-input to the computing device 540. The left computer gaming device 501 is operable in mouse-mode and provides mouse-input to the computing device 540. In some examples, devices 500 and 501 are docked to respective bases and respectively operable in joystick-mode and provide joystick-input to the computing device 540.

The computer gaming device 500 is configured to be operable by a right hand of a user. For example, the housing 504 of the computer gaming device 500 is shaped to conform to a right palm of a user and the housing 505 of the computer gaming device 501 is shaped to conform to a left palm of the user.

The computing device 540 receives input from the first computer gaming device 500 and the second computer gaming device 501. The respective computer gaming devices 500 and 501, can operate coincidentally in mouse- or joystick-mode, or they can operate in mouse- or joystick-mode independently. In the example of FIG. 5, the first computer gaming device 500 operates in mouse-mode and transmits mouse input to the computing device 540. The second computer gaming device 501 is docked with a base 521 and operates in joystick-mode transmitting joystick input to the computing device 540. In an example implementation, the first computer gaming device 500 and the second computer gaming device 501 are docked with a first and second base and operate in joystick-mode concurrently.

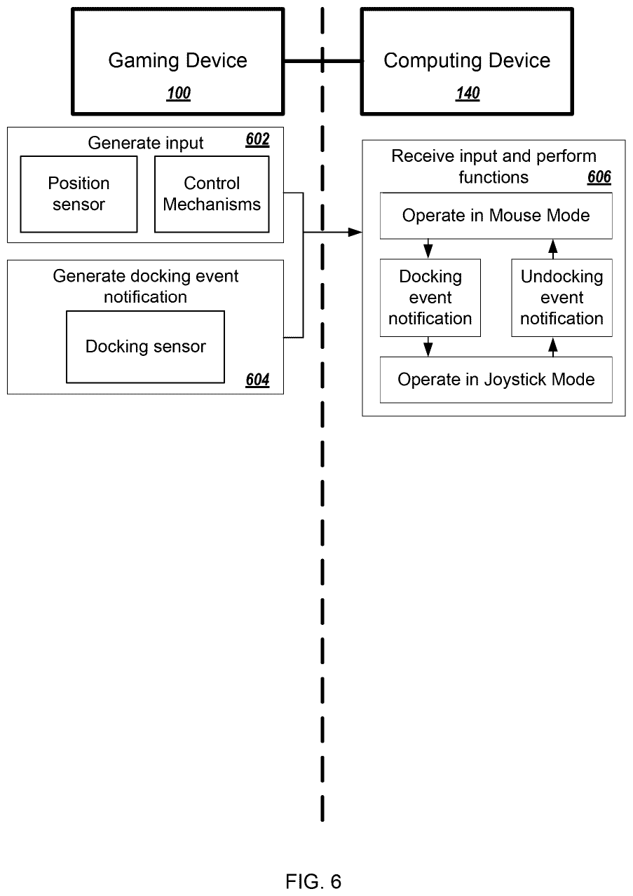

FIG. 6 is a swim lane diagram of the flow of information between the computer gaming device 100 connected to the computing device 140. The user 10 operates the computer gaming device 100 which generates input responsive to the operation (step 602). The input can include position information from a position sensor 106, e.g., mouse-input or joystick-input, and command-input from the user 10 interacting with one or more control mechanisms 102.

The computer gaming device 100 generates a docking event notification based on the docking sensor 110 detecting the presence of the phenomenon (step 604). The user 10 arranges the computer gaming device 100 above the base 120 such that the post 324 is arranged beneath the receptacle 108. The user 10 lowers the computer gaming device 100 onto the base 120 such that the post 324 and the phenomena element enters the receptacle 108 and the docking sensor 110 detects the phenomenon.

The computing device 140 receives the input from the computer gaming device 100 and interprets the input either as mouse-input, e.g., operates in mouse-mode, or as joystick-input, e.g., operates in joystick-mode, and determines whether to perform functions based on mouse-input or joystick-input (step 606) based on the most recently received docking or undocking event notification. If the latest event is a docking event notification, the computing device 140 operates in mouse-mode and performs functions based on the received input being mouse-input. If the latest event is an undocking event notification, the computing device 140 operates in joystick-mode and performs functions based on the received input being joystick-input.

The computer gaming device 100 generates a docking event notification when the docking sensor 110 senses a phenomena indicative of the computer gaming device 100 docking with a base. The docking event notification when the docking sensor 110 senses the presence of the phenomena.

The computing device 140 receives the docking signal to a connected computing device 140. The computing device 140 includes instructions that cause the computing device 140 to operate in a mouse-mode or a joystick-mode based upon the received docking signal.

The computing device 140 operates in joystick-mode by receiving the input from the computer gaming device 100 and interpreting the position information within the joystick-input as a joystick position, e.g., relative to a home position. For example, computer programs that typically interpret position information as joystick information include flight simulation programs. The relative displacement and orientation with respect to the home position are interpreted as roll, yaw, or pitch information.

The computing device 140 operates in mouse-mode by receiving the input from the computer gaming device 100 and interpreting the position information as a mouse position, e.g., relative to a surface. For example, computer programs that typically interpret position information as mouse information include productivity software (e.g., document editing programs) and video game programs. The programs receive and interpret the position information as an absolute change in position directly corresponding with motion of the mouse.

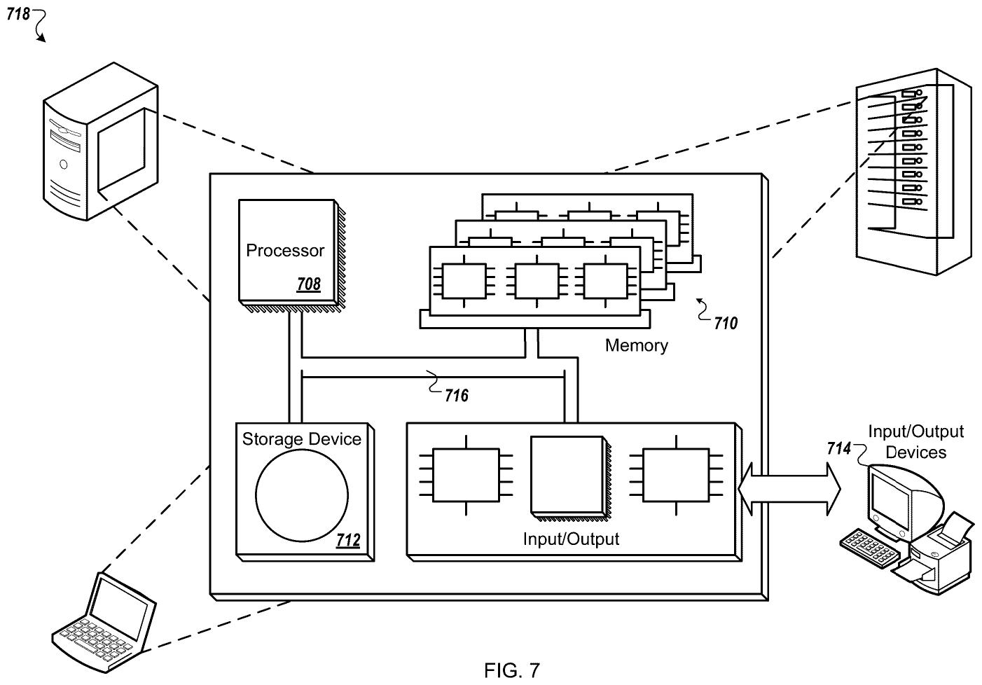

FIG. 7 is a block diagram of an example computer system 700. For example, referring to FIG. 1, computing device 140 could be an example of the system 700 described here. The system 700 includes a processor 710, a memory 720, a storage device 730, and one or more input/output interface devices 740. Each of the components 710, 720, 730, and 740 can be interconnected, for example, using a system bus 750.

The processor 710 is capable of processing instructions for execution within the system 700. The term “execution” as used here refers to a technique in which program code causes a processor to carry out one or more processor instructions. In some implementations, the processor 710 is a single-threaded processor. In some implementations, the processor 710 is a multi-threaded processor. The processor 710 is capable of processing instructions stored in the memory 720 or on the storage device 730. The processor 710 may execute operations such as performing functions in mouse-mode, or performing functions in joystick-mode.

The memory 720 stores information within the system 700. In some implementations, the memory 720 is a computer-readable medium. In some implementations, the memory 720 is a volatile memory unit. In some implementations, the memory 720 is a non-volatile memory unit.

The storage device 730 is capable of providing mass storage for the system 700. In some implementations, the storage device 730 is a non-transitory computer-readable medium. In various different implementations, the storage device 730 can include, for example, a hard disk device, an optical disk device, a solid-state drive, a flash drive, or some other large capacity storage device. In some implementations, the storage device 730 may be a cloud storage device, e.g., a logical storage device including one or more physical storage devices distributed on a network and accessed using a network.

The input/output interface devices 740 provide input/output operations for the system 700. In some implementations, the input/output interface devices 740 can include one or more of a network interface devices, e.g., an Ethernet interface, a serial communication device, e.g., an RS-232 interface, and/or a wireless interface device, e.g., an 802.11 interface, a 3G wireless modem, a 4G wireless modem, etc. A network interface device allows the system 700 to communicate, for example, transmit and receive data. In some implementations, the input/output device can include driver devices configured to receive input data and send output data to other input/output devices, e.g., keyboard, printer, display devices 760, or the computer gaming device 100.

Software can be realized by instructions that upon execution causes one or more processing devices to carry out the processes and functions described above, for example, operating the computing device 140 in mouse-mode or in joystick-mode. Such instructions can include, for example, interpreted instructions such as script instructions, or executable code, or other instructions stored in a computer readable medium.

In some examples, the system 700 is contained within a single integrated circuit package. A system 700 of this kind, in which both a processor 710 and one or more other components are contained within a single integrated circuit package and/or fabricated as a single integrated circuit, is sometimes called a microcontroller. In some implementations, the integrated circuit package includes pins that correspond to input/output ports, e.g., that can be used to communicate signals to and from one or more of the input/output interface devices 740.

Although an example processing system has been described in FIG. 7, implementations of the subject matter and the functional operations described above can be implemented in other types of digital electronic circuitry, or in computer software, firmware, or hardware, including the structures disclosed in this specification and their structural equivalents, or in combinations of one or more of them. Implementations of the subject matter described in this specification, such as storing, maintaining, and displaying artifacts can be implemented as one or more computer program products, i.e., one or more modules of computer program instructions encoded on a tangible program carrier, for example a computer-readable medium, for execution by, or to control the operation of, a processing system. The computer readable medium can be a machine readable storage device, a machine readable storage substrate, a memory device, or a combination of one or more of them.

The term “system” may encompass all apparatus, devices, and machines for processing data, including by way of example a programmable processor, a computer, or multiple processors or computers. A processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks or magnetic tapes; magneto optical disks; and CD-ROM, DVD-ROM, and Blu-Ray disks. The processor and the memory can be supplemented by, or incorporated in, special purpose logic circuitry.

While this specification contains many details, these should not be construed as limitations on the scope of what may be claimed, but rather as descriptions of features specific to particular examples. Certain features that are described in this specification in the context of separate examples can also be combined. Conversely, various features that are described in the context of a single implementation can also be implemented in multiple embodiments separately or in any suitable subcombination.

A number of examples have been described. Nevertheless, it will be understood that various modifications may be made without departing from the spirit and scope of the invention. Accordingly, other examples are within the scope of the following claims.

### Examples

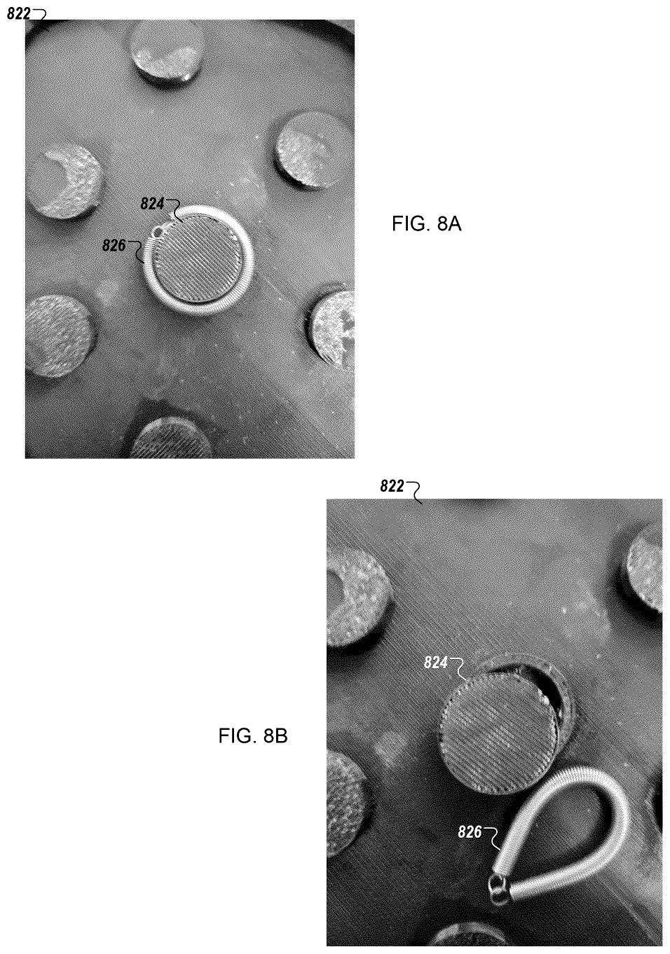

In some examples, a spring is connected at the ends to encircle a post of a dish. The spring provides a rotational restoring force to return the post back to a default orientation when the post of the device is moved (e.g., rotated) away from the default orientation by a docked computer gaming device. FIG. 8A is a photographic depiction of an example of a post 824 extending from a dish 822, and a spring 840 encircling the post 824. FIG. 8B is a photographic depiction of the spring 840 removed from the post 824.

What is claimed is:

1. A system, the system comprising:
one or more processors;
computer memory storing instructions, that when executed by the one or more processors, cause the one or more processors to perform operations comprising:
operate in a mouse-mode, comprising:
receiving mouse inputs from a connected device,
performing functions based upon the mouse inputs;
transition from the mouse-mode to operating in a joystick-mode based upon receiving a docking event notification from the connected device;
operate in a joystick-mode, comprising:
receiving joystick inputs from the connected device,
performing functions based upon the joystick inputs; and
transition from the joystick-mode to operating in the mouse-mode based upon receiving an undocking event notification from the connected device.

2. A computer-readable medium tangibly storing instructions that, when executed by one or more processors of a computing device, cause the one or more processors to perform operations comprising:
operate in a mouse-mode, comprising:
receiving mouse inputs from a connected device,
performing functions based upon the mouse inputs;
transition from the mouse-mode to operating in a joystick-mode based upon receiving a docking event notification from the connected device;
operate in a joystick-mode, comprising:
receiving joystick inputs from the connected device,
performing functions based upon the joystick inputs; and
transition from the joystick-mode to operating in the mouse-mode based upon receiving an undocking event notification from the connected device.

3. A computer gaming device, comprising:
a receptacle with a docking sensor;
a position sensor;
one or more control mechanisms;
a connector;
one or more processors;
the computer gaming device configured to, using the one or more processors:
generate a docking event notification in response to a first change in phenomena sensed by the docking sensor;
generate an undocking event notification in response to a second change in phenomena sensed by the docking sensor;
generate user input commands based upon activation of one or more control mechanisms;
generate position information based upon motion of the device; and
transmit the docking event notification, undocking event notification, user input commands, and position information to a computing device connected via the connector.

4. The computer gaming device of claim 3, further comprising a housing having an upper surface having a dome shape conforming to a palm, wherein the one or more control mechanisms are arranged on the upper surface, and a planar bottom surface wherein the position sensor and receptacle are arranged on the bottom surface.

5. The computer gaming device of claim 4, wherein the housing is composed of a polymer material.

6. The computer gaming device of claim 3, wherein the docking sensor is a Hall Effect sensor, optical sensor, or bump sensor.

7. The computer gaming device of claim 3, wherein the docking sensor is arranged within the receptacle to sense a phenomena from a phenomena element arranged within the receptacle.

8. The computer gaming device of claim 3, wherein position sensor is an optical sensor.

9. The computer gaming device of claim 3, wherein the connector is a wired connector.

10. The computer gaming device of claim 3, wherein the connector is a wireless connector, and further comprises a power source.

11. The computer gaming device of claim 10, further comprising a power connector configured to receive power from an external power source.

12. A system, the system comprising
a computer device, comprising:
one or more processors;
computer memory storing instructions, that when executed by the one or more processors, cause the one or more processors to perform operations comprising:
operate in a mouse-mode and in a joystick-mode, wherein:
while operating in the mouse-mode, receiving position information from a connected device and interpreting the position information as mouse position;
while operating in the joystick-mode, receiving the position information from the connected device and interpreting the position information as joystick position.

13. The system of claim 12, further comprising a computer gaming device, comprising:
a receptacle with a docking sensor;
a position sensor;
one or more control mechanisms;
a connector;
one or more processors;
the computer gaming device configured to, using the one or more processors:
generate a docking event notification in response to a first change in phenomena sensed by the docking sensor;
generate an undocking event notification in response to a second change in phenomena sensed by the docking sensor;
generate user input commands based upon activation of one or more control mechanisms;
generate position information based upon movement of the device; and
transmit the docking event notification, undocking event notification, user input commands, and position information to a computing device connected via the connector.

14. The system of claim 13, comprising a second computer gaming device connected to the computer device.

15. The system of claim 14, comprising a second base corresponding to the second computer gaming device.

16. The system of claim 13, further comprising a base, comprising:
a dish, configured to return to a home position; and
a post connected to the dish, comprising a phenomena element arranged at a position detectable by the docking sensor of the computer gaming device.

17. The system of claim 16, wherein the post comprises a locking element which reversibly couples to the receptacle.

18. The system of claim 12, wherein the joystick information comprises a rotation, a tilt, or a translation.
